(19) United States
(12) Patent Application Publication
(10) Pub. No.: US 2014/0335285 A1
(43) Pub. Date: Nov. 13, 2014

(54) SYSTEM OF SURFACE TREATMENT AND THE METHOD THEREOF

(71) Applicant: NATIONAL TAIWAN UNIVERSITY, Taipei City (TW)

(72) Inventors: Cheng-Che HSU, Taipei City (TW); Chin-chun Wang, Taipei City (TW); Yao-jhen Yang, Taipei City (TW)

(21) Appl. No.: 14/075,709

(22) Filed: Nov. 8, 2013

(30) Foreign Application Priority Data
May 7, 2013 (TW) 102116282

(51) Int. Cl. B05D 3/14

(52) U.S. Cl. CPC B05D 3/145
USPC 427/535; 219/121.59

(57) ABSTRACT

The present disclosure is directed to a system for a surface treatment via plasma generated by a slim and/or flexible electrode and the method thereof. By using the plasma, the surface treatment for an outer wall or an inner wall of a tube can be performed.

### CROSS-REFERENCE TO RELATED APPLICATION AND CLAIM OF PRIORITY

This application claims the benefit of Taiwan Patent Application No. 102116282, filed on May 7, 2013, at the Taiwan Intellectual Property Office, the disclosure of which is incorporated herein in its entirety by reference.

### TECHNICAL FIELD

The present disclosure is directed to a system for a surface treatment via plasma generated by a slim and/or flexible electrode and the method thereof. Through the plasma, the surface treatment for an outer wall or an inner wall of a tube is performed.

### BACKGROUND

Plasma is composed of high-energy electrons, free radicals, ions bringing a positive or negative charge and neutral gas molecules. Because the amount of the positively charged particles equals that of the negatively charged particles in the plasma, the plasma, considered as a whole, is neutral. There are some free electrons in the atmosphere, and those free electrons get energy and therefore are accelerated driven by an external strong electric field. The accelerated electrons have high energy and continuously collide with the surrounding gas molecules. During the collisions, the neutral gas molecules will be excited, ionized or dissociated to become radicals and ions with high energy and reactivity and therefore the plasma is generated.

When performing chemical reactions or materials processing using the plasma with high energy and reactivity, it needs not to be performed in a high temperature and pressure environment like a general chemical process does. In addition, because most chemical processes using the plasma technique are performed in the gas phase, they therefore will be performed faster and more simply than many wet chemical processes. Moreover, if a surface treatment, such as coating, is performed on an inner wall of a hollow tube via wet coating processing, the coating is difficult and the thickness of the coating layer is not easily controlled because of the surface tension of the liquid and the resistance in the hollow tube.

After employing persistent and robust experiments and research, the applicant has finally conceived of a system for surface treatment and the method thereof.

### SUMMARY

The present disclosure is directed to a system for a surface treatment via plasma generated by a slim and/or flexible electrode and the method thereof. Through the plasma, the surface treatment for an outer wall or an inner wall of a tube is performed.

In another aspect, the present disclosure discloses a surface finishing method, comprising steps of: providing a hollow object having a curvy inner wall defining a curvy inner hollow space therein; providing a flexible electrode; inserting the flexible electrode into the hollow object over the curvy inner hollow space; generating a plasma via the flexible electrode; and finishing at least a part of the curvy inner wall using the plasma.

In another aspect, the present disclosure discloses a surface treatment system including: a hollow object having a side wall defining a hollow space therein, wherein the hollow space has a minimum width and a working length, when the minimum width is not smaller than 0.05 mm and smaller than 0.5 mm, the working length is not longer than 3 m, and when the minimum width is not smaller than 0.5 mm, the working length is longer than 60 cm and not longer than 3 m; and an electrode disposed in the hollow space and generating a plasma to finish at least a part of the side wall.

In another aspect, the present disclosure discloses a surface coating method, comprising steps of: providing a curvable electrode; providing a target object having a surface; generating a plasma by the curvable electrode; and coating the surface using the plasma.

### BRIEF DESCRIPTION OF DRAWINGS

FIG. 1a is a diagram showing an embodiment of the present surface treatment apparatus.

FIGS. 1b and 1c are diagrams respectively showing a cross section of a hollow tube on which the surface treatment disclosed in the present disclosure can be performed.

FIG. 1d is a diagram showing a longitudinal section of a hollow tube on which the surface treatment disclosed in the present disclosure can be performed.

FIG. 2 is a diagram showing an embodiment of the performance of a surface treatment in a bending flexible hollow tube.

FIG. 3 shows spectra obtained by using Fourier Transform Infrared Spectroscopy.

FIGS. 4 and 5 show embodiments of the present disclosure.

### DETAILED DESCRIPTION

The present disclosure can be fully understood and accomplished by the skilled person according to the following embodiments. However, the practice of present method is not limited to the following embodiments.

The “surface treatment” disclosed in the present disclosure refers to a process to change the physical, chemical and/or mechanical properties of a surface of an object.

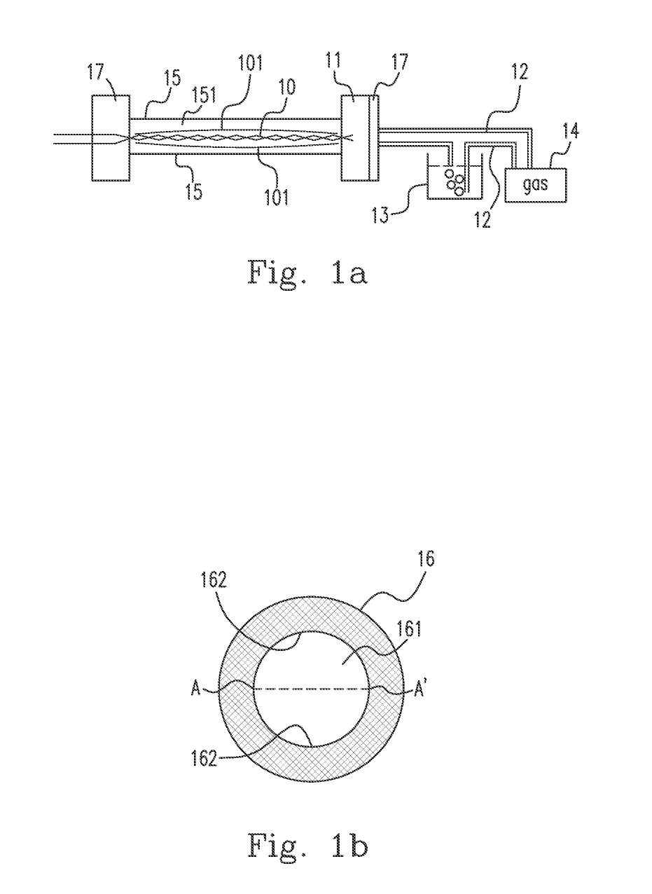

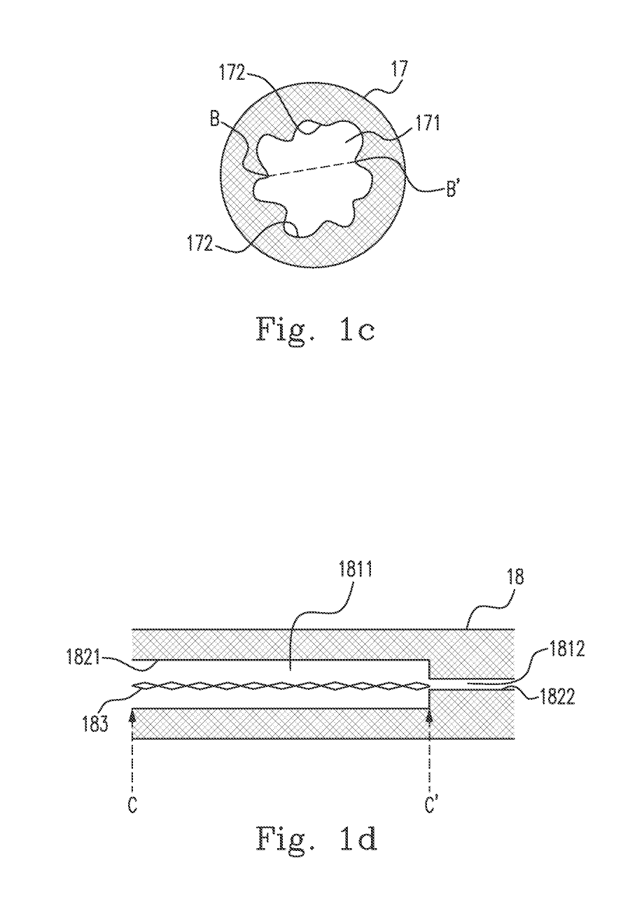

Please refer to FIG. 1a which shows an embodiment of the present surface treatment system. As shown in FIG. 1a, the surface finishing system includes an electrode 10, an auxiliary device 11, a channel 12, a precursor tank 13, a gas tank 14 and a tube 15. The channel 12 is connected to and communicates with the precursor tank 13 and the gas tank 14. The electrode 10 is flexible and made of two conductive wires, each of which is wrapped with an insulation material, and the conductive wires are bent and intertwined to form an electrode set. The two conductive wires are a high voltage electrode terminal and a ground terminal. When a surface treatment process is performed, the electrode 10 is inserted into a hollow tube 15 supported by the auxiliary device 11, where the tube 15 has an inner hollow space 151 communicating with the channel 12 so that precursor gas and carrier gas respectively provided by the precursor tank 13 and the gas tank 14 are injected into the hollow tube 15/inner hollow space 151 and flow therein. The electrode 10 inserted into the inner hollow space 151 will generate and ignite plasma 101 when an appropriate voltage is applied thereto.

In an embodiment, when the diameter of the inner hollow space 151 is not smaller than 0.05 mm and smaller than 0.5 mm, the length of the inner hollow space 151 is not longer than 3 m, and when the diameter of the inner hollow space 151 is not smaller than 0.5 mm, the length of the inner hollow space 151 is longer than 60 cm and not longer than 3 m.

In an embodiment, the electrode 10 is made of two magnet wires bent and intertwined, and each of the magnet wires has a diameter of 70 μm. The electrode made of the magnet wires is inserted into a hollow glass tube having a hollow part with a minimum diameter of 0.26 mm. In the condition of applying AC voltage of 1 kHz, 900 Vpp to the electrode and injecting argon gas with 50 sccm into the hollow part, plasma can be stably ignited in the hollow part of the hollow glass tube. Accordingly, through the plasma generated in the hollow part and accompanied by a suitable precursor gas and/or carrier gas, a surface treatment, such as thin film deposition, can be performed to coat or finish at least a part of an inner wall of the hollow glass tube surrounding the hollow part.

Through the adjustment of the diameter and/or length of the electrode, the electrode can generate the plasma in various hollow tubes having different lengths and/or inner diameters (the diameters of the hollow part) to perform the surface treatment to the surface of the inner wall of the hollow tube using the plasma. In addition, the length of the electrode used to generate the plasma can be longer than, equal to or shorter than the length of the hollow part. That is, the electrode used to generate the plasma can pass through and out of the hollow part or be totally located in the hollow part.

In an embodiment, the electrode used to generate the plasma is located in a part of the whole length of the hollow part so as to generate the plasma to finish the side wall surrounding the part of the whole length of the hollow part. Therefore, by performing the surface treatment process disclosed in this embodiment many times, a single hollow tube in which the side wall located near the hollow part has various kinds or levels of surface treatments performed thereon is obtained.

In FIG. 1a, a moving device 17 is connected to at least one of the electrode 10 and the auxiliary 11 to move the electrode 10 and/or the auxiliary 11 to make the electrode 10 accurately and rapidly move into and out of the tube 15 supported by the auxiliary device 11 to perform the surface treatment on an inner wall of the tube 15 surrounding the hollow space 151. In an embodiment, the system shown in FIG. 1a can be configured with multiple electrodes and auxiliary devices which can be further connected to the moving devices optionally so as to automatically coat/finish the inner walls of the hollow tube supported by the multiple auxiliary devices in a batch process.

In FIG. 1a, the precursor tank 13 and the gas tank 14 are disposed on the same side where the auxiliary device 11 is disposed. That is, the precursor and the carrier gases will flow into the hollow space 151 along the direction opposite that which the electrode 10 is inserted. However, the precursor tank 13 and the gas tank 14, communicating with the inner hollow space 151, can separately and arbitrarily be disposed at any side where the electrode 10 and the auxiliary device 11 are disposed so as to control the flow directions of the precursor and the carrier gases in the inner hollow space 151.

Please refer to FIG. 1b which shows a cross section of a hollow tube on which the surface treatment disclosed in the present disclosure can be performed. In FIG. 1b, a tube 16 has a cylindrical hollow part 161 (so that its cross section is round) and an inner wall 162 defining the hollow part 161. The hollow part 161 has a diameter located between points A and A′ located on the inner wall 162. Using the present surface treatment system or method, the surface treatment can be performed for the hollow tube on the condition that when the diameter of the hollow part is not smaller than 0.05 mm and smaller than 0.5 mm, the length of the hollow part is not longer than 3 m, and when the diameter of the hollow part is not smaller than 0.5 mm, the length of the hollow part is longer than 60 cm and not longer than 3 m.

Please refer to FIG. 1c which shows a cross section of a hollow tube on which the surface treatment disclosed in the present disclosure can be performed. In FIG. 1c, a tube 17 has an irregular-shaped hollow part 171 (so that its cross section is not round) and an inner wall 172 surrounding and defining the hollow part 171. The hollow part 171 does not have a constant diameter due to its irregular shape and has a minimum width. Using the present surface treatment system or method, the surface treatment can be performed on the hollow tube on the condition that when the minimum width of the hollow part is not smaller than 0.05 mm and smaller than 0.5 mm, the length of the hollow part is not longer than 3 m, and when the minimum width of the hollow part is not smaller than 0.5 mm, the length of the hollow part is longer than 60 cm and not longer than 3 m. For the tube 17, the minimum width of the hollow part 171 refers to the distance between points B and B′ located on the inner wall 172. If the hollow tube is a one having a cylindrical hollow part with a constant diameter, the constant diameter is also the minimum width of this hollow tube.

Please refer to FIG. 1d which shows a longitudinal section of a hollow tube on which the surface treatment disclosed in the present disclosure can be performed. In FIG. 1d, a tube 18 has a first hollow part 1811 and a second hollow part 1812, where an inner wall 1821 surrounding the first hollow part 1811 is suitable for the surface treatment disclosed in the present disclosure to be performed, and the minimum width of the second hollow part is shorter than that of the first hollow part 1811 so that an electrode 183 cannot generate the plasma to perform the surface treatment for an inner wall 1822 surrounding the second hollow part 1812. The first hollow part 1811 has two terminal points C and C′ and a length between points C and C′ which is defined as a working length, and the side wall located therein, i.e. the inner wall 1821, can be coated/finished by the electrode 183. Using the present surface treatment system or method, the surface treatment can be performed on the hollow tube on the condition that when the minimum width of the hollow part is not smaller than 0.05 mm and smaller than 0.5 mm, the working length of the hollow part is not longer than 3 m, and when the minimum width of the hollow part is not smaller than 0.5 mm, the working length of the hollow part is longer than 60 cm and not longer than 3 m.

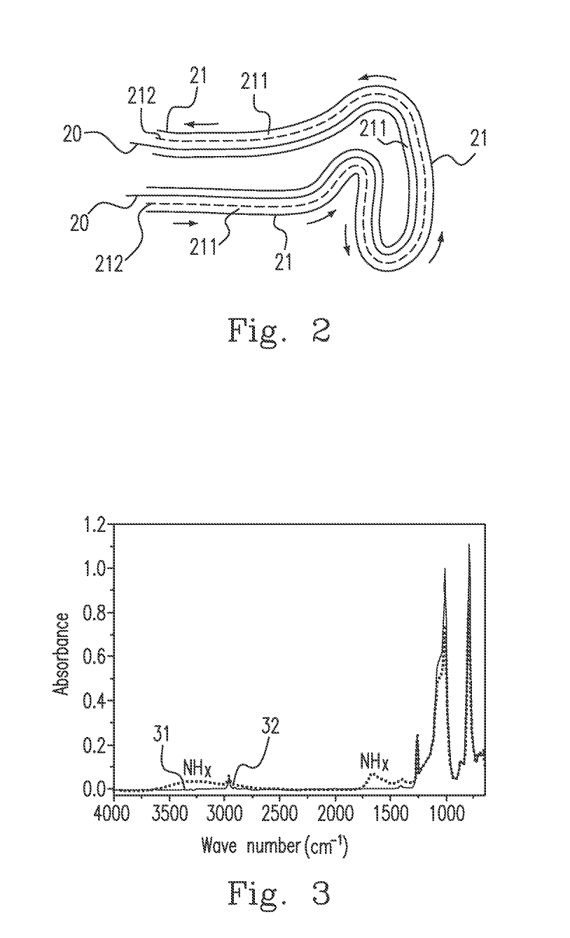

Please refer to FIG. 2 which a diagram showing an embodiment of the performance of a surface treatment in a curvy flexible hollow tube. In FIG. 2, an electrode 20 is inserted into a curvy inner hollow space 211 of a flexible and curvy hollow silicone tube 21 along a longitudinal axis 212 thereof, where the longitudinal axis 212 is curvy corresponding to the tube 21. The electrode 20 is made of two magnet wires bent and intertwined, and each of the magnet wires is coated with a dielectric layer having a thickness of 10 μm and has a diameter of 150 lam. The tube 21 has a diameter of 3 mm and a length of 20 cm and the hollow space 211 has a diameter of 1 mm (i.e. an inner diameter of the tube 21). When the electrode 20 is inserted into the hollow space 211 along the longitudinal axis 212 as shown in FIG. 2, vapor of propylamine (C₃H₉N), which is the precursor, is injected into the tube 21/hollow space 211 by a carrier gas, argon, with a flow speed of 50 sccm. Then, an AC voltage of 1.2 kV, 10 kHz is applied to the electrode 20 to generate plasma from the electrode 20 in the hollow space 211. Through the plasma generated by the electrode 20, a surface treatment through deposition of amine-containing thin film is performed on the side wall surrounding the hollow space 211.

Regarding the propylamine, the molecular weight is 59.11, the melting point is −83° C., the boiling point is 48° C., the density is 0.719 g/cm³ (at 25° C.), the vapor pressure is 33.06 kPa (at 20° C.). The propylamine is a liquid and water-solvable at room temperature (about 25° C.).

Please refer to FIG. 3 which shows spectra obtained by using Fourier Transform Infrared Spectroscopy (FTIR). Specifically, the spectrum 31 (presented by the continuous line) is obtained by analyzing the surface of the side wall surrounding the hollow space 211 of tube 21 with FTIR, where there is no surface treatment performed on the surface. The spectrum 32 (presented by the discontinuous line) is obtained by analyzing the surface of the side wall surrounding the hollow space 211 of tube 21 with FTIR, where the surface was treated using the surface treatment through deposition of amine-containing thin film as mentioned above. As shown in FIG. 3, the peaks of the functional group NHₓ can be observed in the spectrum 32. That is, the above-mentioned surface treatment through deposition of amine-containing thin film can indeed be performed on the inner wall of the thin, long and curvy flexible tube, such as the tube 21, using the plasma generated by the electrode located therein.

In an embodiment, an electrode is inserted into a flexible and curvy hollow silicone tube, having a length of 1 m, a diameter of 3 mm and a curvy inner hollow space with a diameter of 1 mm, and generates plasma therein. On the condition that argon gas and vapor of allylamine (C₃H₅NH₂) are injected into the inner hollow space, thin film deposition with amine functional groups is performed on the surface of the inner wall surrounding the inner hollow space by the generated plasma. Regarding the allylamine, the molecular weight is 57.09, the melting point is −88° C., the boiling point is 53° C., the density is 0.763 g/cm³, the vapor pressure is 28.18 kPa. The allylamine is a liquid and water-solvable at room temperature (about 25° C.).

The amine-containing thin film has many applications, such as being applied to organic conductive film, wastewater treatment, functionalization for carbon nanotubes or microspheres, increasing the biocompatibility of biomaterial, microfluidics and sensor technologies. Specifically, because the polyallylamine contains a hydrophilic functional group of amine, the amine-containing film can be deposited on an object and therefore the object will be suitable to be a substrate in which 1) protein and metabolite can seep thereinto and 2) cell can be fixed.

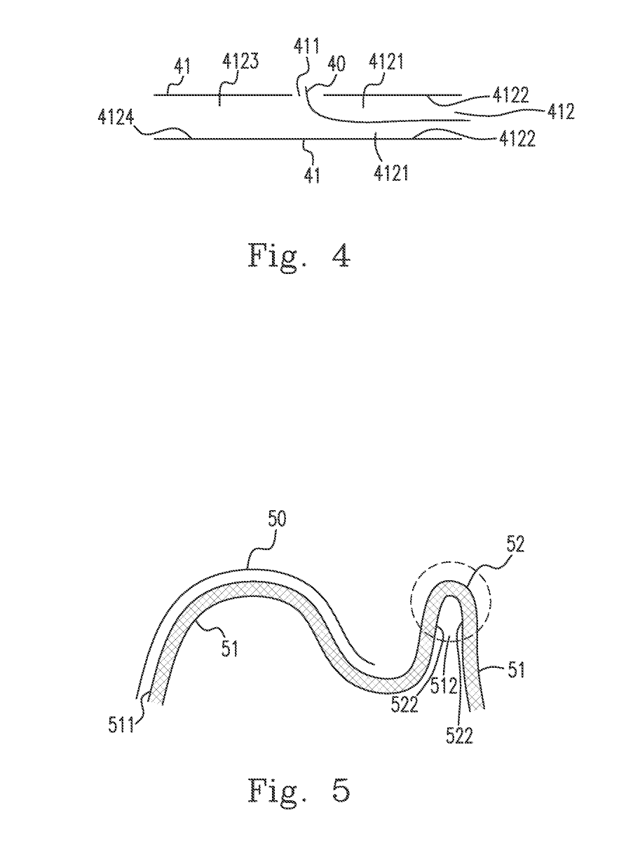

Please refer to FIG. 4 which shows an embodiment of the present disclosure. In FIG. 4, an electrode 40 is flexible, inserted into a first hollow space 4121 of a hollow tube 41 from a first opening 411 and passes through and protrudes the hollow tube 41 from the second opening 412. Due to the relative positions of the first and the second openings 411 and 412 and the first hollow space 4121, the electrode 40 will be bent in the first hollow space 4121 during the insertion as shown in FIG. 4. Then, the surface treatment is performed by causing the electrode 20 to generate the plasma in the first hollow space 4121 to coat (a surface of) an inner wall 4122 disposed beside the first hollow space 4121. Moreover, by inserting an electrode into a second hollow space 4123 and performing the surface treatment using the plasma generated by the electrode, an inner 4124 disposed beside the second hollow space 4123 is coated/finished. Accordingly, through the openings disposed on the hollow tube and communicating with the hollow space thereof, this embodiment can perform a surface treatment to coat/finish a specific part on an inner wall of the hollow tube.

Please refer to FIG. 5 which shows an embodiment of the present disclosure. In FIG. 5, a curvable electrode 50 is flexible and bent along an outside of a curvy target object 51 due to its flexibility. Then, through applying the appropriate voltage to the electrode 50 and optionally further supplying a suitable precursor gas and/or carrier gas, plasma can be ignited and generated by the electrode 50 to coat a curvy surface of a curvy outer wall 511 of the curvy target object 51.

In addition, the curvy target object 51 is bent to form a curvy portion 52 by which a gap 512 and a curvy outer wall 522 are formed, and a curvy surface of the curvy outer wall 522 defines and partially surrounds the gap 512. Then, by inserting an electrode into the gap 512 and applying the appropriate voltage to the electrode, and optionally further supplying a suitable precursor gas and/or carrier gas, plasma can be ignited and generated by the electrode to coat the curved surface of the curvy outer wall 512 of the curvy target object 51. In an embodiment, the electrode is properly configured first and then the curvy target object 51 is bent to form the curvy portion 52 to surround the electrode and contain the electrode in the gap 512. Then the curvy surface of the curvy outer wall 512 of the curvy target object 51 can be coated by performing the above-mentioned procedures.

Accordingly, the present disclosure discloses a surface treatment which can partially or totally coat an outer surface of a curvy object using a thin and flexible electrode even when the outer surface is located in a gap.

In an embodiment, the electrode used to generate the plasma is a flexible one and made of two conductive wires, each of which is wrapped with an insulation material, and the conductive wires are bent and intertwined to form an electrode set. The electrode set can generate a dielectric barrier discharge to perform the surface treatment. In general, the dielectric layer of the electrodes used to generate the dielectric barrier discharge is thicker than 0.5 mm and the gap between the electrodes is larger than 0.5 mm. Accordingly, the AC voltage applied to the electrodes to generate and maintain stable plasma must be higher than 5 kV (rms voltage). On the contrary, the electrode used to generate the plasma in the present embodiments can be made of two conductive wires, each of which is wrapped with the insulation material to form an insulation layer thereon. Because the insulation layer is thin, for example, thinner than 20 μm, and the gap between the two electrodes is very small, for example, shorter than 0.5 mm, 300 V of voltage is sufficient to generate stable plasma when applied to the present electrodes. Moreover, the dielectric barrier discharge can generate a wide and uniform discharge and therefore stable and excellent coating/finishing is obtained using this surface treatment with the dielectric barrier discharge.

In another embodiment, the electrode used to generate the plasma is made of a slim substrate having two surfaces opposite of each other, each of which has a conductive material disposed thereon.

In an embodiment, the voltage applied to the electrode to generate the plasma ranges between 1-15 kHz and 300-1000 V (rms). In addition, the plasma used in the present embodiment is operated with a working voltage lower than 12 kVpp, and preferably lower than 8 kVpp, and more preferably lower than 1.4 kVpp by adjusting the material of the electrode and/or the thickness of the insulation layer coated on the electrode.

In an embodiment, the plasma used to perform the surface treatment is operated with a working voltage, which has a voltage amplitude lower than 12 kV, and preferably lower than 8 kV, and more preferably lower than 1.4 kV.

In an embodiment, the plasma used to perform the surface treatment can be a dielectric barrier discharge, corona discharge, electron beam plasma, microwave plasma or radio frequency plasma, and generated and applied at a pressure ranging between 0.1 Ton and 5 atm. The voltage driving the plasma can be one of DC, AC, pulsed DC or pulsed AC.

In an embodiment, the carrier gas for the plasma can include hydrogen, oxygen, argon, helium, nitrogen, carbon-containing gases, and/or air. The precursor can be a liquid, a solid and/or a gas and include one or more chemical substance(s).

The tube mentioned in the present disclosure can be a hard or a soft/flexible tube and made of a material consisting of polymer, silicone, glass, metal, Teflon and the combinations thereof. For example, by treating a surface of (inner and/or outer walls of) a Teflon hollow tube with the plasma generated in the gas mixed with argon and nitrogen, the surface will be converted from hydrophobic to hydrophilic following the surface treatment. In addition, the hollow part/space of the hollow tube/object mentioned in the present disclosure can have a linear, a curved and/or a manifold shape. The different hollow parts/spaces of a single hollow tube/object mentioned in the present disclosure can have various diameters (as shown in FIG. 1d). In addition, the inner/side wall surrponding the hollow part/space of the hollow tube/object mentioned in the present disclosure can have a smooth surface, a regular or an irregular uneven surface or the combinations thereof.

### Embodiment

Embodiment 1 is a surface finishing method, comprising steps of: providing a hollow object having a curvy inner wall defining a curvy inner hollow space therein; providing a flexible electrode; inserting the flexible electrode into the hollow object over the curvy inner hollow space; generating plasma via the flexible electrode; and finishing at least a part of the curvy inner wall using the plasma.

Embodiment 2 is a method according to Embodiment 1, where the hollow object has at least one opening connected to and communicating with the curvy inner hollow space for inserting the flexible electrode through the opening into the curvy inner hollow space.

Embodiment 3 is a method according to one of Embodiments 1 and 2, where the hollow object has a first opening and a second opening, both of which are connected to and communicate with the curvy inner hollow space for inserting the flexible electrode through the first opening into the curvy inner hollow space, and further protruding from the second opening out of the hollow object.

Embodiment 4 is a method according to any one of Embodiments 1-3, where the curvy inner hollow space has a curvy longitudinal axis, and the flexible electrode is inserted into the curvy inner hollow space along the curvy longitudinal axis and bent during the insertion.

Embodiment 5 is a method according to any one of Embodiments 1-4, further comprising a step of: applying a voltage to the flexible electrode to generate the plasma, wherein the voltage has an amplitude not higher than 8 kV.

Embodiment 6 is a method according to any one of Embodiments 1-5, further comprising a step of: applying a voltage to the flexible electrode to generate the plasma, wherein the voltage has an amplitude not higher than 1.4 kV.

Embodiment 7 is a method according to any one of Embodiments 1-6, where the flexible electrode is made of two conductive wires, each of which is wrapped with an insulation material, and the conductive wires are bent and intertwined to form an electrode set to generate the plasma.

Embodiment 8 is a method according to any one of Embodiments 1-7, wherein the plasma is a dielectric barrier discharge.

Embodiment 9 is a method according to any one of Embodiments 1-8, where the curvy inner hollow space has a minimum width and a working length, the inner wall located in the working length is finished by the plasma, when the minimum width is not smaller than 0.05 mm and smaller than 0.5 mm, the working length is not longer than 3 m, and when the minimum width is not smaller than 0.5 mm, the working length is longer than 60 cm and not longer than 3 m.

Embodiment 10 is a surface treatment system including: a hollow object having a side wall defining a hollow space therein, wherein the hollow space has a minimum width and a working length, when the minimum width is not smaller than 0.05 mm and smaller than 0.5 mm, the working length is not longer than 3 m, and when the minimum width is not smaller than 0.5 mm, the working length is longer than 60 cm and not longer than 3 m; and an electrode disposed in the hollow space and generating a plasma to finish at least a part of the side wall.

Embodiment 11 is a surface treatment system according to Embodiment 10 further comprising: an auxiliary device supporting the hollow object; and a moving device connected to at least one of the auxiliary device and the electrode to move the electrode to pass in and out of the hollow space, where when the electrode is located in the hollow object, the electrode generates the plasma to finish the part of the side wall.

Embodiment 12 is a surface treatment system according to one of Embodiments 10 and 11, where the electrode is flexible and made of two conductive wires, each of which is coated with an insulation material, and the conductive wires are bent and twisted each other to form an electrode set to generate the plasma.

Embodiment 13 is a surface treatment system according to any of Embodiments 10-12, where the conductive wires are magnet wires.

Embodiment 14 is a surface coating method, comprising steps of: providing a curvable electrode; providing a target object having a surface; generating plasma using the curvable electrode; and coating the surface using the plasma.

Embodiment 15 is a method according to Embodiment 14, where the curvable electrode is flexible and made of two conductive wires, each of which is wrapped with an insulation material, the conductive wires are bent and intertwined to form an electrode set, the target object is a hollow object having a curvy inner wall having the surface and defining a curvy inner hollow space therein, and the method further comprises steps of: inserting the electrode set into the hollow object over the inner hollow space, wherein the electrode set is curved in the inner hollow space; and generating the plasma using the electrode set to finish the surface.

Embodiment 16 is a method according to one of Embodiments 14 and 15, where the surface is a curvy surface.

Embodiment 17 is a method according to Embodiment 14, where the curvable electrode is flexible and made of two conductive wires, each of which is wrapped with an insulation material, the conductive wires are bent and intertwined to form an electrode set, the target object has a curvy outer wall having the surface, and the electrode set generates the plasma to finish the surface.

Embodiment 18 is a method according to one of Embodiments 14 and 17, where the electrode set is curved along the curvy outer wall and the surface is curvy.

Embodiment 19 is a method according to Embodiment 14, where the target object has a curvy portion, the curvy portion has a curvy outer wall having the surface, the surface is a curvy surface and defines a gap therein, and the method further comprises steps of: inserting the electrode set into the gap; and generating the plasma using the electrode set to finish the curvy surface.

Embodiment 20 is a method according to Embodiment 14 further comprising steps of: bending the target object to form a bent portion, wherein the bent portion forms a gap to receive therein the curvable electrode and has a bent outer wall having the surface, and the surface is curvy and partially surrounds the gap; and generating the plasma by the curvable electrode to finish the curvy surface.

While this disclosure is described in terms of what is presently considered to be the most practical and preferred embodiments, it is to be understood that the disclosure is not limited to the disclosed embodiments. Therefore, it is intended to cover various modifications and similar arrangements included within the spirit and scope of the appended claims, which are to be accorded with the broadest interpretation so as to encompass all such modifications and similar structures.

What is claimed is:

1. A surface finishing method, comprising steps of:
providing a hollow object having a curvy inner wall defining a curvy inner hollow space therein;
providing a flexible electrode;
inserting the flexible electrode into the hollow object over the curvy inner hollow space;
generating a plasma via the flexible electrode; and
finishing at least a part of the curvy inner wall by the plasma.

2. The surface finishing method according to claim 1, wherein the hollow object has at least one opening connected to and communicating with the curvy inner hollow space for inserting the flexible electrode through the opening into the curvy inner hollow space.

3. The surface finishing method according to claim 1, wherein the hollow object has a first opening and a second opening, both of which are connected to and communicate with the curvy inner hollow space for inserting the flexible electrode through the first opening into the curvy inner hollow space, and further protruding from the second opening out of the hollow object.

4. The surface finishing method according to claim 1, wherein the curvy inner hollow space has a curvy longitudinal axis, and the flexible electrode is inserted into the curvy inner hollow space along the curvy longitudinal axis and bent during the insertion.

5. The surface finishing method according to claim 1 further comprising a step of:
applying a voltage to the flexible electrode to generate the plasma, wherein the voltage has an amplitude not higher than 8 kV.

6. The surface finishing method according to claim 1 further comprising a step of:
applying a voltage to the flexible electrode to generate the plasma, wherein the voltage has an amplitude not higher than 1.4 kV.

7. The surface finishing method according to claim 1, wherein the flexible electrode is made of two conductive wires, each of which is wrapped with an insulation material, and the conductive wires are bent and intertwined to form an electrode set to generate the plasma.

8. The surface finishing method according to claim 1, wherein the plasma is dielectric barrier discharge.

9. The surface finishing method according to claim 1, wherein the curvy inner hollow space has a minimum width and a working length, the inner wall located in the working length is finished by the plasma, when the minimum width is not smaller than 0.05 mm and smaller than 0.5 mm, the working length is not longer than 3 m, and when the minimum width is not smaller than 0.5 mm, the working length is longer than 60 cm and not longer than 3 m.

10. A surface treatment system, comprising:
a hollow object having a side wall defining a hollow space therein, wherein the hollow space has a minimum width and a working length, when the minimum width is not smaller than 0.05 mm and smaller than 0.5 mm, the working length is not longer than 3 m, and when the minimum width is not smaller than 0.5 mm, the working length is longer than 60 cm and not longer than 3 m; and
an electrode disposed in the hollow space and generating a plasma to finish at least a part of the side wall.

11. The surface treatment system according to claim 10 further comprising:
an auxiliary device supporting the hollow object; and
a moving device connected to at least one of the auxiliary device and the electrode to move the electrode to pass in and out of the hollow space, wherein when the electrode is located in the hollow object, the electrode generates the plasma to finish the part of the side wall.

12. The surface treatment system according to claim 10, wherein the electrode is flexible and made of two conductive wires, each of which is coated with an insulation material, and the conductive wires are bent and twisted each other to form an electrode set to generate the plasma.

13. The surface treatment system according to claim 12, wherein the conductive wires are magnet wires.

14. A surface coating method, comprising steps of:
providing a curvable electrode;
providing a target object having a surface;
generating a plasma by the curvable electrode; and
coating the surface by the plasma.

15. The surface coating method according to claim 14, wherein the curvable electrode is flexible and made of two conductive wires, each of which is wrapped with an insulation material, the conductive wires are bent and intertwined to form an electrode set, the target object is a hollow object having a curvy inner wall having the surface and defining a curvy inner hollow space therein, and the method further comprises steps of:
inserting the electrode set into the hollow object over the inner hollow space, wherein the electrode set is curved in the inner hollow space; and
generating the plasma by the electrode set to finish the surface.

16. The surface coating method according to claim 15, wherein the surface is a curvy surface.

17. The surface coating method according to claim 14, wherein the curvable electrode is flexible and made of two conductive wires, each of which is wrapped with an insulation material, the conductive wires are bent and intertwined to form an electrode set, the target object has a curvy outer wall having the surface, and the electrode set generates the plasma to finish the surface.

18. The surface coating method according to claim 17, wherein the electrode set is curved along the curvy outer wall and the surface is curvy.

19. The surface coating method according to claim 14, wherein the target object has a curvy portion, the curvy portion has a curvy outer wall having the surface, the surface is a curvy surface and defines a gap therein, and the method further comprises steps of:
inserting the electrode set into the gap; and
generating the plasma by the electrode set to finish the curvy surface.

20. The surface coating method according to claim 14, further comprising steps of:
bending the target object to form a bent portion, wherein the bent portion forms a gap to receive therein the curvable electrode and has a bent outer wall having the surface, and the surface is curvy and partially surrounds the gap; and
generating the plasma by the curvable electrode to finish the curvy surface.
